(19) United States
(12) Patent Application Publication
(10) Pub. No.: US 2005/0024269 A1
(43) Pub. Date: Feb. 3, 2005

(54) Emergency deployable GPS antenna

(76) Inventors: Michael Kotzin, Buffalo Grove, IL (US); Thomas J. Walczak, Woodstock, IL (US); Eric Krenz, Crystal Lake, IL (US)

Correspondence Address: MOTOROLA INC, 600 NORTH US HIGHWAY 45, ROOM AS437, LIBERTYVILLE, IL, 60048-5343, US

(21) Appl. No.: 10/628,200

(22) Filed: Jul. 28, 2003

(51) Int. Cl. H01Q 1/24

(52) U.S. Cl. 343/702

(57) ABSTRACT

The electronic device is for at least one of transmitting and receiving signals, has a housing 500 and at least a GPS (Global Positioning System) antenna 510 that is operatively connected to the housing 500. A control system 708 automatically moves the GPS antenna 510 from a docked position relative to the housing 500 to a deployed position relative to the housing 500 in response to an occurrence of at least one predetermined event.

### FIELD OF THE INVENTION

In general terms, the present invention relates to electronic devices that have deployable antennas, and in general to handheld two-way radio transceivers that receive GPS (Global Positioning System) signals.

### BACKGROUND OF THE INVENTION

Handheld two-way radio transceivers (also known as cell phones) are well known in the art. Recent designs for such transceivers do not require a manually extendable antenna for cellular operation. It is also known to provide cellular phones with the feature of receiving a GPS signal from a GPS satellite for determining location of the cell phone. Cell phones receive GPS signals so that operators in a public safety answering center are able to determine the location of the cell phone by receiving a GPS signal via the cell phone. This feature assists in locating cell phones and their users during emergency situations. In the Global Positioning System each GPS satellite transmits its own position, its time, and a long pseudo random noise code. The noise code is used by the receiver to calculate range. Satellite position and time are derived from on-board celestial navigation equipment and atomic clocks accurate to one second in 300,000 years. But the ranging is the heart of GPS. Both in the receiver, and in the satellite, a very long sequence of apparently random bits are generated. By comparing internal stream of bits in the receiver to the precisely duplicate received bits from the satellite, and “aligning” the two streams, a shift error or displacement can be calculated representing the precise travel time from satellite to receiver. Since the receiver also knows the precise position of the satellite, and its range from the receiver, a simple triangulation calculation can give two dimensional position (lat/long) from three satellites and additional elevation information from a fourth.

In many situations a blocked environment such as inside a building or a parking garage, GPS does not work well because of the limited visibility the GPS antenna has to the positioning satellites. In such cases, the transceiver may receive inadequate signal power to effectively determine a position of the transceiver. A further factor for inadequate signal power is that the presence of the user in close proximity to the GPS antenna reduces the signal power. Field testing with server assisted GPS technology has shown that the sensitivity of transceivers is approximately −150 dBm. Testing has also shown that the signal strength of the satellites is approximately −155 dBm to −160 dBm in blocked environments. This means that an increase in sensitivity of between 5 dB and 10 dB is required for improved performance. In the prior art this level of improvement is achieved using larger antennas that are held away from the body of the user and that are manually deployed. However, the design of modern day cell phones does not provide the option of an antenna which can be manually deployed by the user.

Thus, there is a need in the prior art for an automatically deployable antenna for receiving GPS signals, especially in emergency situations.

### BRIEF DESCRIPTION OF THE DRAWINGS

The features of the present invention which are believed to be novel are set forth with particularity in the appended claims. The invention, together with further objects and advantages, may best be understood by reference to the following description taken in conjunction with the accompanying drawings, in the several figures of which reference numerals identify like elements, and in which:

FIG. 1 is a general diagram depicting a cell phone that receives signals from a GPS satellite and that communications with the public safety answering center;

FIG. 2 is a block diagram of the FIG. 1 cell phone;

FIGS. 3 and 4 are flow diagrams depicting the steps of the method of the present invention;

FIG. 5 depicts a handheld two-way radio transceiver according to the present invention with a GPS antenna in a docked position;

FIG. 6 depicts the FIG. 5 transceiver with the GPS antenna in a deployed position;

FIG. 7 depicts an embodiment of the present invention for deploying the GPS antenna from a docked position to a deployed position;

FIGS. 8-11 depict alternative structures for deployment of the GPS antenna;

FIG. 12 depicts an embodiment of the present invention in which the GPS antenna is an inflatable monopole antenna, the antenna being depicted in a docked position;

FIG. 13 depicts the FIG. 12 antenna in a deployed position;

FIGS. 14-16 depict various embodiments of an inflatable monopole GPS antenna according to the present invention;

FIG. 17 depicts the monopole GPS antenna relative to a microstrip patch antenna for cellular and for GPS operation;

FIG. 18 depicts a further embodiment for deployment of the GPS antenna according to the present invention;

FIG. 19 depicts yet another embodiment for deployment of the GPS antenna according to the present invention.

FIG. 20 depicts the general method of the present invention.

### DETAILED DESCRIPTION OF A PREFERRED EMBODIMENT OF THE INVENTION

In general terms the present invention is an electronic device for at least one of transmitting and receiving signals. The device has a housing and at least a GPS antenna that is operatively connected to the housing. A control system automatically moves the GPS antenna from a docked position relative to the housing to a deployed position relative to the housing in response to an occurrence of at least one predetermined event.

More specifically, the present invention is a handheld two-way radio transceiver having a helix cellular/GPS antenna. In addition, an inflatable monopole GPS antenna has a docked position relative to the housing and a deployed position relative to the housing. An ejection device inflates the monopole GPS antenna and thereby moves the antenna from the docked position to the deployed position. A control system automatically deploys the GPS antenna utilizing the ejection device in response to an occurrence of at least one predetermined event. The invention is further a method for deploying a GPS antenna in an electronic device and comprises the steps of: detecting the occurrence of at least one predetermined event; and automatically moving the GPS antenna from the docked position relative to a housing of the electronic device to the deployed position relative to the housing of electronic device; the deployed position providing increased signal quality for receiving a GPS signal. In an embodiment of the present invention the predetermined event is the activation of a series of predetermined keys, such as 911, on a keypad of the transceiver. The event can also be reception of a GPS request from a public safety answering center, or detection of an inadequate signal level from the GPS satellite.

The present invention provides an emergency deployable GPS antenna system for use on a portable device, such as a cell phone (also referred to as a subscriber unit). This antenna may be deployed either by the user or by a public safety answering center. The antenna, once deployed, provides significantly improved performance. The antenna system may or may not be reusable. Deployment of the antenna may be initiated by the user by pressing a particular button on the cell phone or by activation of a certain sequence of keys on a keypad of the cell phone, such as 911. The cell phone, upon detection of an emergency call, automatically deploys the GPS antenna if the signal quality of a received GPS signal is below a predetermined threshold.

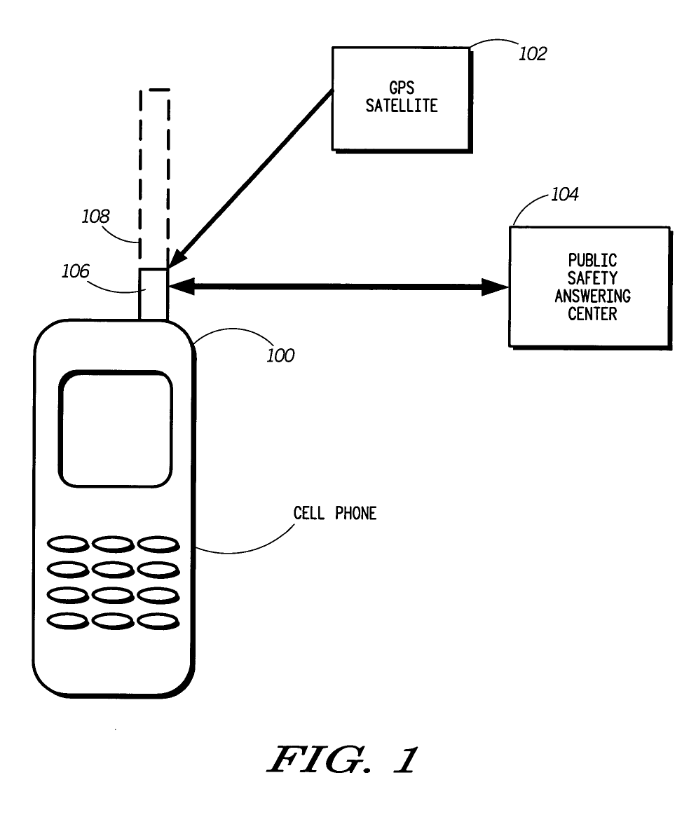

FIG. 1 depicts a handheld two-way radio transceiver, or cell phone 101 that receives signals from a GPS satellite 102 and that also transmits and receives signals with a public safety answering center 104. The cell phone 100 has a built in cellular/GPS antenna 106 for receiving and sending signals. In addition, an inventive feature of the cell phone is the provision of a further GPS antenna 108 which has a docked position and a deployed position, the deployed position being indicated by the dotted line in FIG. 1.

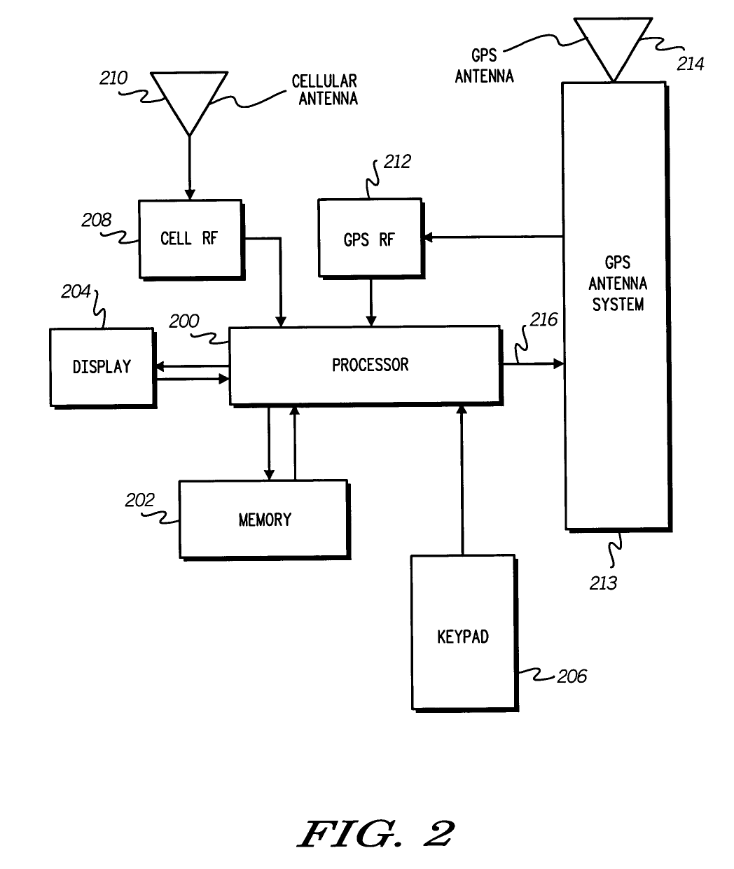

FIG. 2 is a block diagram of the cell phone 100 in FIG. 1. A processor 200 is operatively connected with a memory 202, a display 204 and a keypad, or input device, 206. The processor 200 is also connected to a radio frequency circuit 208 for processing received signals from a cellular antenna 210 on cellular frequencies. The processor 200 also receives data from a GPS radio frequency circuit 212 that processes GPS signals received by a GPS antenna system 213. According to the present invention the GPS antenna 214 has a docked position and a deployed position. The processor 200 therefore has a signal line 216 for causing the GPS antenna system 213 to move the GPS antenna 214 from the docked position to the deployed position as will be explained below.

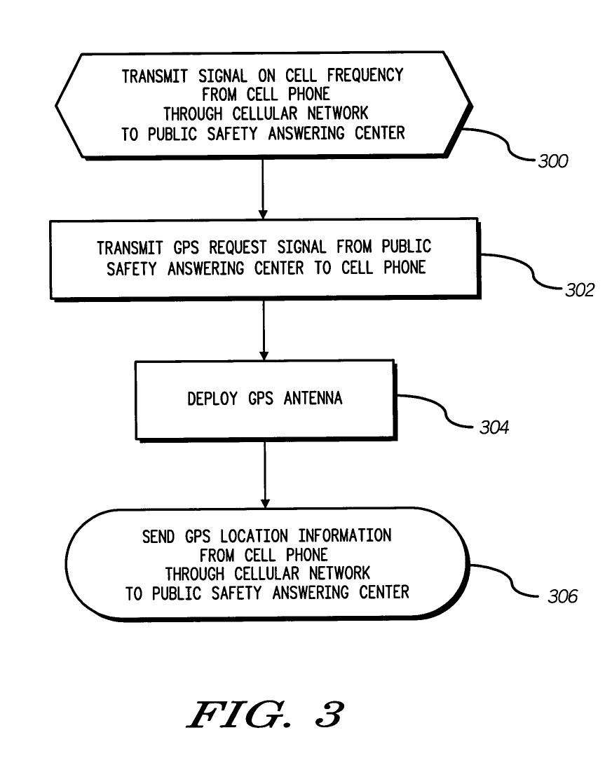

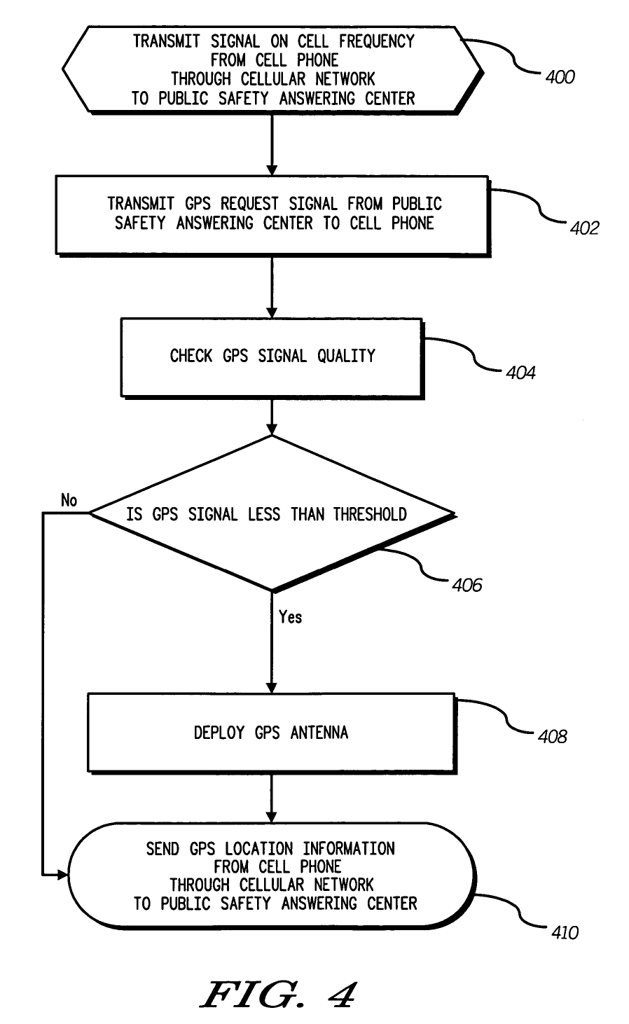

General operation of the cell phone depicted in FIGS. 1 and 2 is set forth in the flow charts of FIGS. 3 and 4. In the FIG. 3 flowchart, the user of the cell phone transmits a signal on a cellular frequency, the signal being sent from the cell phone through a cellular network to a public safety answering center in step 300. In a second step 302 the public safety answering center sends a signal over the cell frequency or other suitable frequency to the cell phone requesting transmission of a GPS signal. It should be noted that this GPS signal can also be automatically sent as soon as the cell phone sends a cellular frequency call to the public safety answering center. In response to the request by the public safety answering center, in step 304 the cell phone automatically deploys the GPS antenna and in step 306 sends a GPS location information through the cellular network to the public safety answering center.

In another version of the present invention, as set forth in FIG. 4, in a first step 400 the user of the cell phone transmits a signal over the cellular frequency to the public safety answering center. The public safety answering center then in a second step 402 requests from the cell phone that a GPS signal be sent. In step 404 the processor 200 automatically checks signal quality (such as signal strength) of the GPS signal that is received by the cell phone. The cell phone then compares the signal strength to a predetermined antenna deployment threshold in step 406. If the signal strength is below the predetermined antenna deployment threshold, then in step 408 the cell phone automatically deploys the GPS antenna, moving it from its docked position to the deploy position. In step 410, the cell phone then sends GPS location information, derived from a received GPS signal, to the public safety answering center. If in step 406 the signal strength is greater than the predetermined antenna deployment threshold then the cell phone does not automatically deploy the GPS antenna and proceeds to step 410, sending the GPS signal to the public safety answering center.

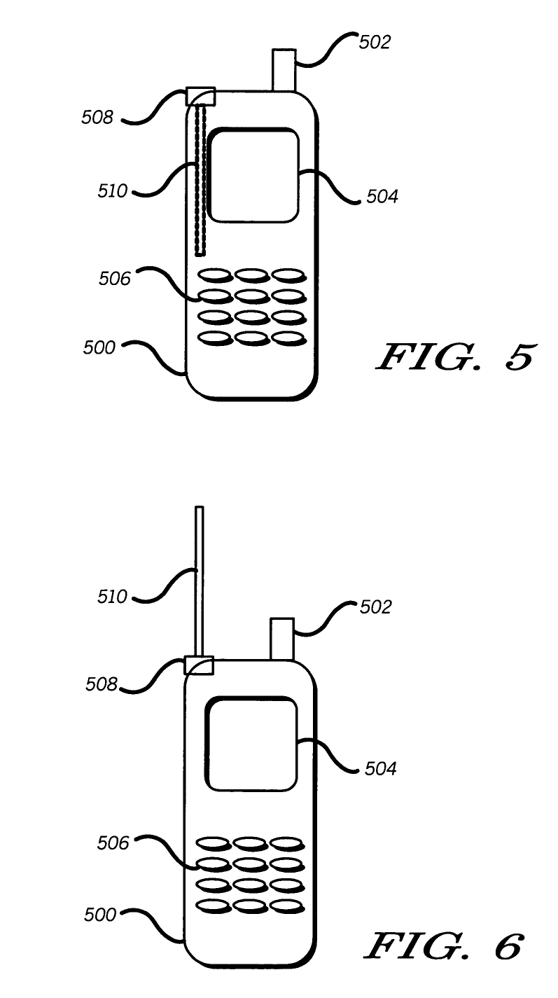

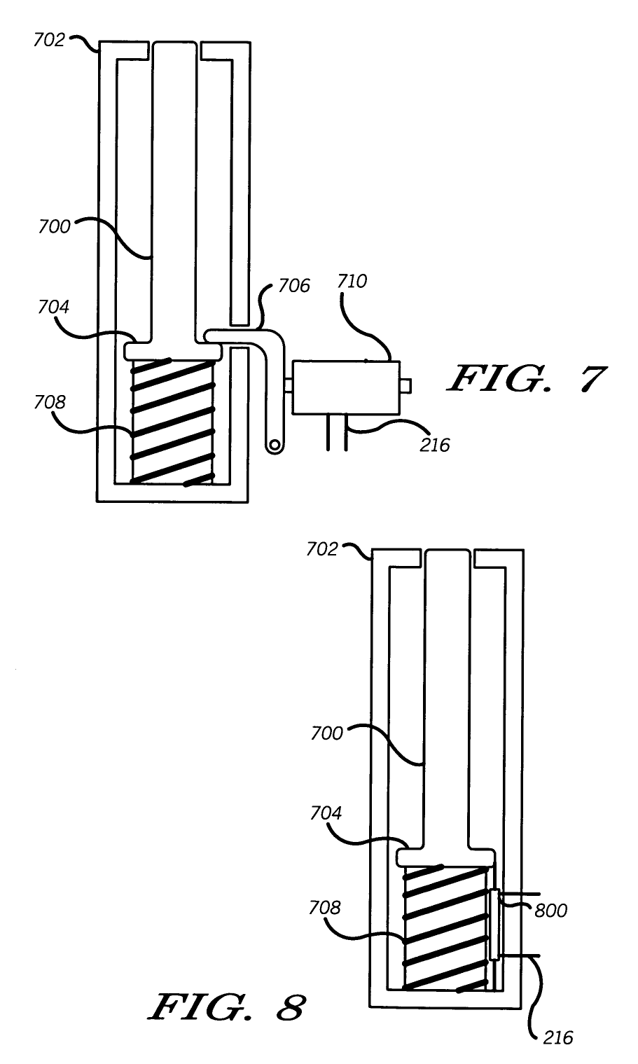

FIGS. 5 and 6 depict a cell phone 500 having a standard cell phone antenna 502, a display area 504 and a key pad 506. In addition, the cell phone 500 has a patch antenna 508, as known in the art, for receiving GPS signals. The cell phone 500 furthermore has a half wave monopole antenna 510, as known in the art, for receiving GPS signals as well. FIG. 5 shows the monopole antenna in a docked position in FIG. 5 and shows the monopole antenna 510 in a deployed position in FIG. 6. In the docked position the antenna 510 is not connected to the GPS circuit, while in the deployed position the antenna 510 is connected to the GPS circuit. In the docked position of FIG. 5 the monopole antenna 510 is contained within the cell phone of 500 and moves linearly to the deployed position depicted in FIG. 6. A number of configurations for the structure of the deployable GPS antenna 510 in FIGS. 5 and 6 are depicted in detail in FIGS. 7-11 although any suitable linear or nonlinear configuration may be used. In FIG. 7, a GPS antenna 700 is contained in a docked position within an antenna chamber 702. The GPS antenna 700 has a base 704 (also referred to in general as a connection section) which is engaged by detent 706. A spring structure 708 (also generally referred to as an ejection device) moves the GPS antenna 700 from the docked position to the deployed position when the detent 706 is withdrawn from engagement with the base 704 by a solenoid 710 that is activated by a signal on signal line 216. The spring structure can have a variety of forms including helical and non-helical configurations.

In FIG. 8 the base 704 of the GPS antenna 700 is retained in the docked position by a fusable link 800 that is connected between the base 704 and a bottom of the antenna chamber 702. When the fusable link 800 is blown, the spring structure 708 moves the GPS antenna 700 from the docked position to the deployed position.

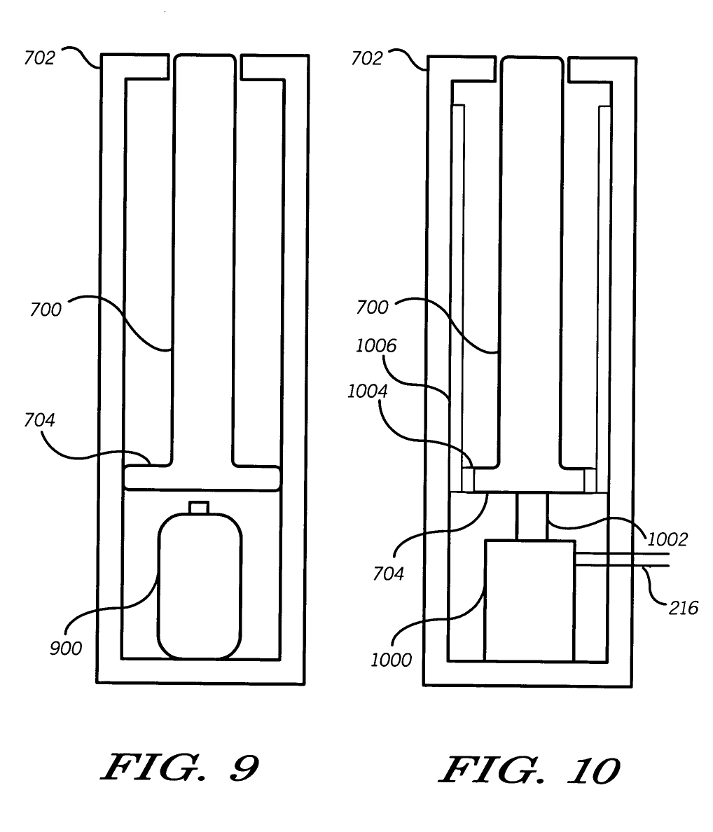

In FIG. 9 a compressed gas cylinder 900 is located below the base 704 of the GPS antenna 700. The base 704 in dimensioned to form a sufficient seal with an interior of the antenna chamber 702 such that when the compressed gas cylinder 900 releases gas, the antenna 700 moves from the docked position to the deployed position by expansion of the gas below the base 704.

In FIG. 10, a motor 1000 has a shaft 1002 attached to the base 704 of the GPS antenna 700. The antenna 700 has teeth 1004 which engage teeth 1006 on an interior surface of the antenna chamber 702 such that, when the motor turns the antenna 700, it moves from the docked position to the deployed position. The teeth 1004/1006 are configured to advance the antenna when the motor 1000 rotates the antenna 700.

In FIG. 11 a solenoid 1100 is connected to the base 704 of the antenna 700 and has a plunger 1102 which moves the antenna 700 from the docked position to the deployed position when a signal is received by the solenoid 1100.

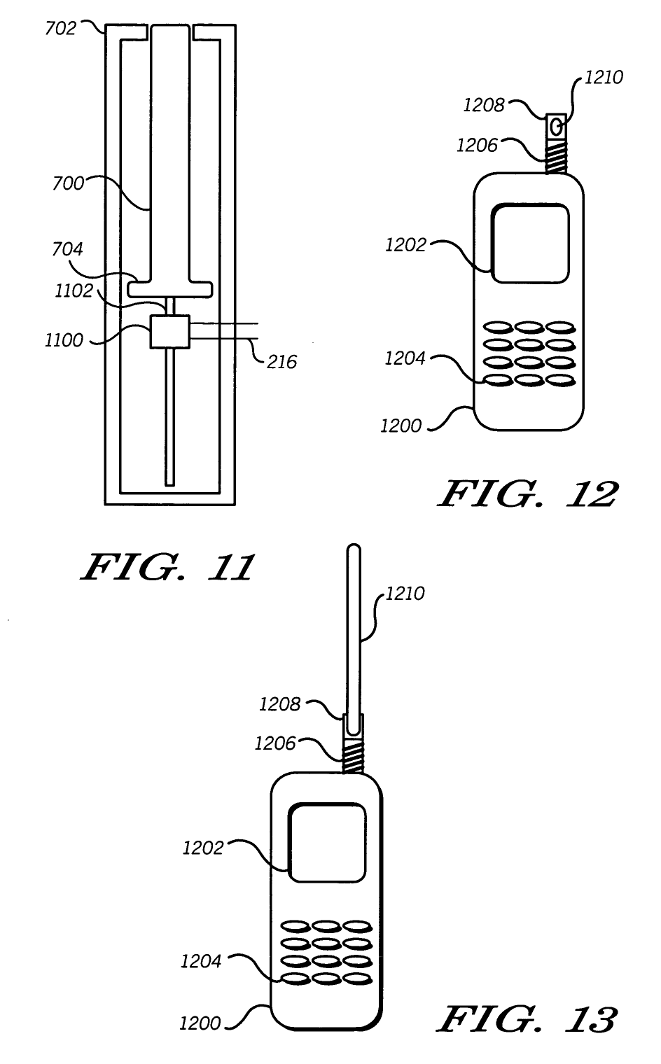

FIGS. 12 and 13 depict a cell phone 1200 having a display area 1202 and a keypad 1204. The cell phone 1200 has a combined cell and GPS antenna 1206. This antenna 1206 is, for example, a helical antenna. In an upper portion 1208 of the combined cell and GPS antenna 1206 is stowed in a docked position a half-wave parasitic GPS antenna 1210. FIG. 13 shows the half-wave parasitic GPS antenna 1210 in the deployed position. In the docked position shown in FIG. 12 the half-wave parasitic GPS antenna 1210 has a configuration such that it has substantially little influence on reception of signals by the combined cell and GPS antenna 1206. In the deployed position depicted in FIG. 13 the GPS antenna 1210 operates by capacitive end coupling with the antenna 1206. GPS antenna 1210 can be, for example, a metallized mylar balloon which is inflated to move the GPS antenna from the docked position to the deployed position. Inflatable structures can also be used that have coatings of aluminum, silver or copper, for example. Coatings of other substances suitable for receiving signals could also be utilized for the GPS antenna 1210. The GPS antenna 1210 can be fully metallized or partially metallized in a particular pattern to support a desired antenna operation.

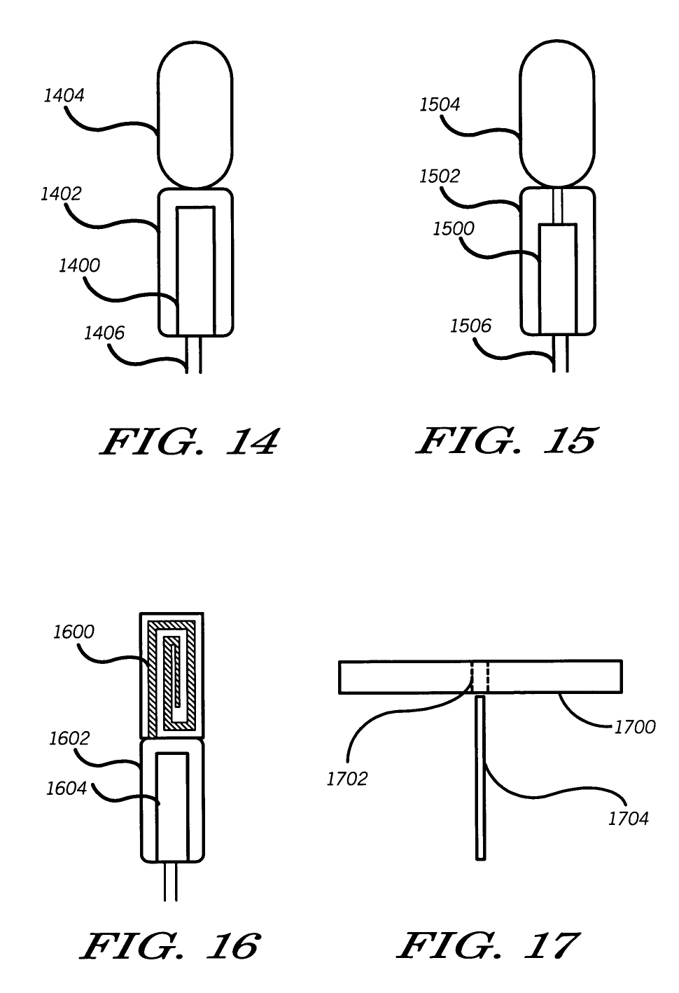

FIG. 14 depicts an airbag-type device 1400 which is contained within a combined cell and GPS antenna 1402. A deployable GPS antenna 1404 is attached atop the combined cell and GPS antenna 1402 and is operatively connected with the “airbag” 1400. When a signal is received on leads 1406, the airbag 1400 inflates the mylar antenna 1404 causing it to be moved to its deployed position. The “airbag” device 1400 can be of a chemical type similar to those used in airbag structures for automobiles, for example.

FIG. 15 shows a compressed gas cylinder 1500 contained within the combined cell and GPS antenna 1502 which is used for inflating the mylar GPS antenna 1504 that is affixed atop the antenna 1502 and that is operatively connected to the compressed gas cylinder 1500. A signal on leads 1506 effects operation of the compressed gas cylinder 1500.

FIG. 16 shows that the GPS mylar antenna 1600 can be folded or coiled into a predetermined shape for the docked position atop the combined cell and GPS antenna 1602. The GPS antenna 1600 is inflated from the docked position to the deployed position by, for example, an airbag 1604 contained in the combined cell and GPS antenna 1602.

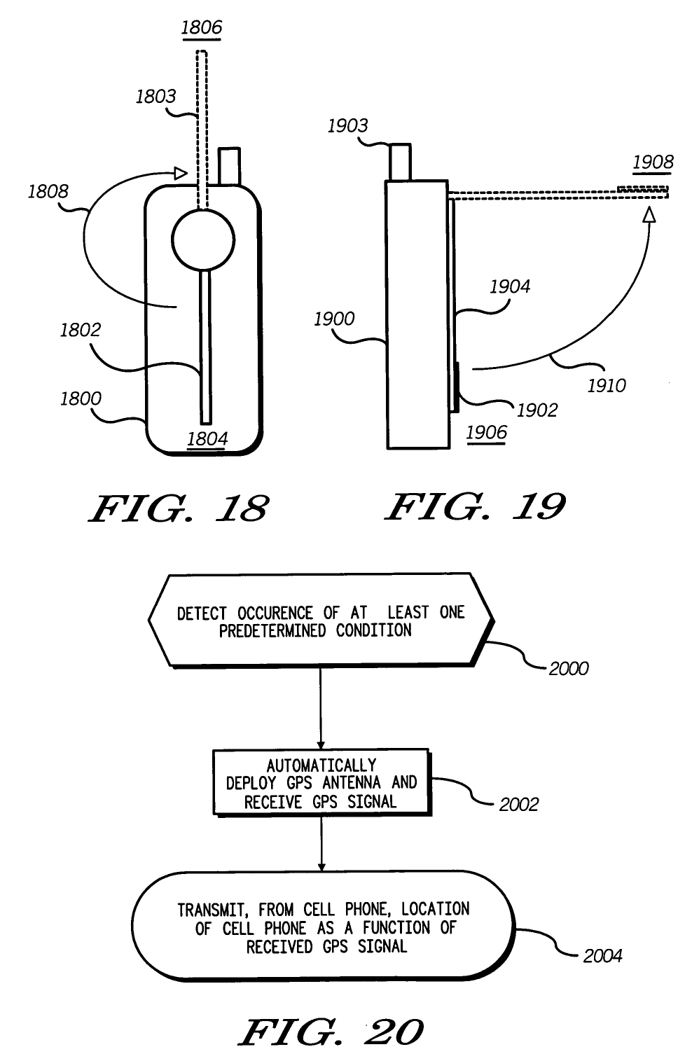

FIGS. 5 and 6 depicted a cell phone 500 having a patch antenna 508 for receiving GPS signals under “normal” conditions, that is, when signal levels received by the patch antenna 508 are strong enough to be usable. FIG. 17 shows in more detail a patch antenna 1700 which has a central aperture 1702. It is known in the art that a central aperture 1702 can be formed in the patch antenna 1700 without degrading operation of the patch antenna 1700. The GPS antenna 1704 is deployed from a docked position to a deployed position through the center aperture 1702 of patch antenna 1700. It should be noted that patch antennas can be used not only for receiving GPS signals but also to receive cell phone signals on cell frequencies. Thus, various combinations of the patch antennas and helix antennas along with the half-wave monopole emergency GPS antennas can be utilized in cell phones according to the present invention.

Whereas the GPS antenna was moved linearly in the cell phone depicted in FIGS. 5 and 6, and inflated in the cell phone depicted in FIGS. 12 and 13, the GPS antenna can also be rotated from a docked position to a deployed position. A monopole antenna 1803 is provided for receiving and transmitting of cell frequencies. As shown in FIG. 18 a cell phone 1800 has a GPS antenna 1802 which has a docked position 1804 alongside the cell phone 1800 and a deployed position 1806 which is above the cell phone 1800. The GPS antenna 1802 is rotated as indicated by arrow 1808 from the docked position to the deployed position under the conditions as described above.

In FIG. 19 a cell phone 1900 has a monopole antenna 1903 for receiving and transmitting on cell frequencies and a patch antenna 1902 for receiving GPS signals. The patch antenna 1902 is mounted on a movable boom 1904. The patch antenna 1902 has a docked position alongside the cell phone 1900 and a deployed position as shown in FIG. 19 which is away from the cell phone 1900. The patch antenna 1902 springs out from the docked position 1906 to the deployed position 1908 as indicated by arrow 1910. Various spring devices or flexing of the boom 1904 can be utilized for moving the patch antenna 1902 on the boom 1904 from the docked position 1906 to the deployed position 1908.

In the various structures depicted herein the emergency GPS antenna may or may not be reusable. For example, a mechanism as depicted in FIG. 7 which is a detent 706 to engage a base 704 of a GPS antenna 700 provides for a reusable GPS antenna 700. The embodiment depicted in FIGS. 12 and 13 in which the GPS antenna is inflated is not reusable. However, the cell phone could be reusable by replacing the inflated GPS antenna with a new docked GPS antenna. According to the present invention the GPS antenna is moved from the docked position to the deployed position automatically when certain conditions occur. Such conditions, for example, may be when the user enters “911” or other numeric or alphanumeric keys on the cell phone, or when a signal strength of a received GPS signal is below a predetermined threshold. The GPS antenna may also be automatically deployed on receiving a signal from the public safety answering center.

In the general terms the method of the present invention is depicted in FIG. 20. In the first step 2000 the occurrence of at least one predetermined event is detected. In response thereto the GPS antenna is automatically deployed in step 2002. A received GPS signal is utilized in step 2004 to transmit the location of the cell phone to, for example, a public safety answering center.

Thus, the present invention fulfills the need in the prior art for an automatically deployable antenna for receiving GPS signals, especially in emergency situations.

It should be understood that the implementation of other variations or modifications of the present invention and its various aspects would be apparent to those of ordinary skill in the art, and that the invention is not limited to the specific embodiment described therein. For example, the present invention encompasses other types of electronic equipment, than cell phone. Also, various other devices and methods can be used to deploy the antenna. It is therefore contemplated to cover by the present invention, any and all modifications, variations or equivalents that fall within the spirit and scope of the basic underlying principals disclosed and claimed herein.

1. An electronic device for at least one of transmitting and receiving signals, comprising:
a housing;
at least a GPS (Global Positioning System) antenna operatively connected to the housing;
a deployment system operatively connected to the GPS antenna, the deployment system moving the GPS antenna from a docked position relative to the housing to a deployed position relative to the housing in response to an occurrence of at least one predetermined deployment event.

2. The device according to claim 1, wherein the electronic device is a handheld two-way radio transceiver.

3. The device according to claim 1, wherein the GPS antenna is a monopole antenna substantially contained in an antenna chamber in the housing, wherein the deployment system has an ejection device, and wherein the GPS antenna has a connection section operatively connected to the ejection device which moves the GPS antenna from the docked position to the deployed position.

4. The device according to claim 3 wherein the ejection device is a spring member, and wherein a latch mechanism retains the monopole GPS antenna in the antenna chamber for a docked position.

5. The device according to claim 3 wherein the ejection device is a fusable link which connects the connection section of the GPS antenna to a retaining surface of the antenna chamber.

6. The device according to claim 3, wherein the ejection device is a compressed gas device that is located between the connection section of the GPS antenna and a retaining surface of the antenna chamber when the GPS antenna is in the docked position.

7. The device according to claim 3 wherein the ejection mechanism is a motor operatively connected to the GPS antenna, and wherein the GPS antenna and the antenna chamber have a gear structure such that when the motor is energized, the GPS antenna moves from the docked position to the deployed position.

8. The device according to claim 3, wherein the ejection mechanism is a solenoid having a coil and a plunger, wherein the solenoid is contained within a bottom area of the antenna chamber, wherein the plunger has one end connected to the connection section of the GPS antenna, and wherein upon energizing the coil of the solenoid, the plunger moves the antenna from the docked position to the deployed position.

9. The device according to claim 3, wherein the ejection mechanism is an airbag-type device, wherein the GPS antenna is an inflatable monopole GPS antenna that is operatively connected to the airbag-type device, and wherein upon receiving a signal the airbag-type device inflates the GPS antenna thereby moving the GPS antenna from the docked position to the deployed position.

10. The device according to claim 1, wherein the GPS antenna is an inflatable antenna, wherein the GPS antenna has a compressed configuration for the docked position and inflated by the control system to a monopole GPS antenna configuration for the deployed position.

11. The device according to claim 10, wherein the GPS monopole antenna is deployed by an airbag-type device.

12. The device according to claim 10, wherein the monopole GPS antenna is deployed by a compressed gas device.

13. The device according to claim 1, wherein the device further comprises a quadrifilar helix cellular/GPS antenna on which an inflatable monopole GPS antenna is operatively connected.

14. The device according to claim 13 wherein the inflatable GPS monopole antenna is inflated to move the GPS monopole antenna from a the docked position to the deployed position by one of an airbag-type device and a compressed gas type device.

15. The device according to claim 1, wherein the device further comprises a microstrip patch antenna on the housing for use as at least one of a cellular antenna and a GPS antenna, wherein the microstrip patch antenna has an aperture through which a monopole GPS antenna is deployed from the docked position within the housing of the device to the deployed position substantially external to the housing.

16. The device according to claim 1, wherein the GPS antenna is a monopole GPS antenna having a first end attached to the housing and a second end attached to a microstrip patch antenna, wherein the microstrip antenna is at least a cellular patch antenna, wherein in the docked position the second end of the GPS antenna is substantially adjacent the housing and wherein in the deployed position the second end of the GPS antenna is orientated away from the housing.

17. The device according to claim 1, wherein the GPS antenna is rotated from a docked position adjacent the housing to a deployed position in which the GPS antenna has one end positioned away from the housing.

18. A method for deploying a GPS (Global Positioning System) antenna in a handheld two-way radio transceiver, comprising the steps of:
activating at least one key on a keypad of the transceiver;
transmitting in response thereto a cellular signal and a GPS signal to a public safety command center;
determining at the public safety answering center if the GPS signal is sufficient to determine a location of the transceiver;
transmitting, if the GPS signal is not sufficient for determining the location of the transceiver, a request signal from the public safety command center to the transceiver;
in response to the request signal, automatically moving the GPS antenna from a docked position relative to a housing of the transceiver to a deployed position relative to the housing of the transceiver; and
automatically transmitting a further GPS signal to the public safety answering center.

19. A method for determining the location of a portable handheld two way radio transceiver, comprising the steps of:
transmitting a signal on a cellular frequency from the transceiver to a public safety answering center;
transmitting a GPS (Global Positioning System) request from the public safety answering center to the transceiver;
automatically deploying a GPS antenna in the transceiver; and
sending a GPS signal from the transceiver to the public safety answering center.

20. The claim according to claim 19, wherein the method further comprises, after receiving by the transceiver the GPS request from the public answering center, checking a signal strength of a received GPS signal in the transceiver, comparing the signal strength of the received GPS signal to a predetermined threshold, deploying the GPS antenna when the signal strength is below the threshold as determined by the comparison, and sending a new received GPS signal from the transceiver to the public safety answering center.

21. A method for deploying a GPS (Global Positioning System) antenna in an electronic device, comprising the steps of:
detecting an occurrence of at least one deployment event;
automatically moving, in response to the detection of an occurrence of the at least one deployment event, the GPS antenna from a docked position relative to a housing of the electronic equipment to a deployed position relative to the housing of the electronic equipment, the deployed position of the GPS antenna providing increased signal quality for receiving a GPS signal; and
transmitting the GPS signal.

22. The device according to claim 21, wherein the GPS antenna is an inflatable antenna that is in a compressed configuration for the docked position and inflated to a monopole GPS antenna configuration for the deployed position.

23. The device according to claim 21, wherein the occurrence of a deployment event is at least one of activation by a user of at least one predetermined key on the electronic device, activation by the user of a predetermined sequence of keys on the electronic device, and receiving a signal from a public safety command center.
